(19) United States
(12) Patent Application Publication
(10) Pub. No.: US 2025/0283559 A1
(43) Pub. Date: Sep. 11, 2025

(54) FLEXIBLE HOSE MATERIAL AND A WATER PIPE MADE OF THE FLEXIBLE HOSE MATERIAL

(71) Applicant: JINAN UNIVERSITY, Guangzhou (CN)

(72) Inventors: Qiwei Wang, Guangzhou (CN); Peng Zhang, Guangzhou (CN); Yingfei Yang, Guangzhou (CN); Lin Cao, Guangzhou (CN)

(21) Appl. No.: 18/666,700

(22) Filed: May 16, 2024

(30) Foreign Application Priority Data
Mar. 8, 2024 (CN) 202410265194.1

(51) Int. Cl. F16L 11/08; F16L 11/00

(52) U.S. Cl. CPC F16L 11/08; F16L 11/005

(57) ABSTRACT

The present disclosure discloses a flexible hose material and a water pipe made of the flexible hose material. Raw material components of the flexible hose material includes following ingredients in weight parts: thermoplastic rubber 80 parts to 100 parts, polypropylene 20 parts to 40 parts, wear resistant fillers 30 parts to 40 parts, anti-aging agent 1 part to 3 parts, dispersing agent 1 part to 3 parts and coupling agent 1 part to 3 parts. The flexible hose material of the present disclosure has good wear resistance and anti-aging performance; the problems of complex structure and high production cost are solved; and has important disclosure value. The water pipe made of the flexible hose material has features of a transverse expansion and longitudinal expansion, its expansion coefficient reaches more than 2.5 times; a number of charging and discharging reaches more than 1000 times, and has a long service life.

### CROSS REFERENCE TO RELATED APPLICATIONS

This application claims foreign priority of Chinese Patent Application No. 202410265194.1, filed on Mar. 8, 2024 in the China National Intellectual Property Administration, the disclosures of all of which are hereby incorporated by reference.

### TECHNICAL FIELD

The present disclosure relates to the technical field of hose and flexible hose material, specifically to a flexible hose material and a water pipe made of the flexible hose material.

### BACKGROUND OF THE PRESENT INVENTION

US application of U.S. Pat. No. 16,681,769 discloses an extensible flexible hose include one elastic inner layer, one elastic textile reinforcement layer and one elastic outer layer, where the elastic textile reinforcement layer placed on the outer surface of the elastic inner layer, the elastic outer layer disposed on the elastic textile reinforcement layer, while the elastic inner layer and the elastic textile reinforcement layer are reciprocally coupled, the elastic outer layer and the uncovered surface area of the elastic inner layer are reciprocally joined to form a unitary tubular member. The elastic textile reinforcement layer comprising a twill weave textile layer, with stretch yarns longitudinally distributed among. The objective of the application of U.S. Pat. No. 16,681,769 is to improve the phenomenon that the telescopic water pipe is liable to be damaged due to strong friction between inner core and outer sheath, to prolong the service life of the extensible flexible hose.

The extensible flexible hose disclosed by the application of U.S. Pat. No. 16,681,769 has been successfully applied, but it needs to be composed of three layers of structure, such as elastic inner layer, elastic fabric reinforcement layer and elastic outer layer; and there are problems of complex structure and high production cost. Due to the poor wear resistance of the current flexible hose material, replacing the above structure with only one layer of hose construction makes the service life of the hose shortened. Thus, the present disclosure provides a flexible hose material with good wear resistance, which has important disclosure value for extending the service life of the hose.

### SUMMARY OF PRESENT INVENTION

In order to overcome at least one of the technical problems existing in the prior art, the present disclosure provides a flexible hose material and a water pipe made of the flexible hose material.

The above technical problems to be solved by the present disclosure are realized through the following technical solutions:

The present disclosure firstly provides a flexible hose material, and its raw material components include following ingredients in parts by weight:
thermoplastic rubber 80 parts to 100 parts, polypropylene 20 parts to 40 parts, wear resistant fillers 30 parts to 40 parts, anti-aging agent 1 part to 3 parts, dispersing agent 1 part to 3 parts and coupling agent 1 part to 3 parts;
the wear resistant fillers include kaolins and the quartz powders.

The present disclosure improves the wear resistant performance of the flexible hose material by adding the wear resistant fillers in the flexible hose material, and the wear resistant fillers are composed of kaolins and quartz powders. In addition, the anti-aging agents are also added to the flexible hose material to improve the anti-aging performance of the flexible hose material.

In an embodiment, raw material components of the flexible hose material include following ingredients in parts by weight: thermoplastic rubber 90 parts to 100 parts, polypropylene 20 parts to 30 parts, wear resistant fillers 30 parts to 35 parts, anti-aging agent 2 parts to 3 parts, dispersing agent 1 part to 2 parts and coupling agent 1 part to 2 parts.

In another embodiment, raw material components of the flexible hose material include following ingredients in parts by weight: thermoplastic rubber 90 parts, polypropylene 30 parts, wear resistant fillers 35 parts, anti-aging agent 2 parts, dispersing agent 1 part and coupling agent 1 part.

In another embodiment, a weight ratio of kaolins to quartz powders in the wear resistant fillers is 3:5 to 3:1.

In another embodiment, a weight ratio of kaolins to quartz powders in the wear resistant fillers is 4:1.

In another embodiment, the wear resistant fillers is a modified wear resistant fillers; the modified wear resistant fillers is prepared by the following steps:
(1) mixing the kaolins and the quartz powders evenly, and then adding the kaolins and the quartz powders to water, to obtain a kaolins and quartz powders dispersion after ultrasonic stirring;
(2) adding molybdenum pentachloride and vanadium tetrachloride to the kaolins and quartz powders dispersion, adding potassium bicarbonate after stirring for 10 min to 20 min, and then stirring continuously for 120 min to 200 min; carrying out a filtration operation after stirring, and collecting solid filter slags after the filtration operation is completed;
(3) calcining the solid at 900° C. to 1100° C. for 3 h to 5 h; obtaining the calcined solids after the end of calcination, and the calcined solids are the modified wear resistant fillers.

The inventor of this disclosure found that when compared with the modified wear resistant fillers with the unmodified filler that composed of only kaolins and quartz powders, the modified wear resistant fillers greatly improve the wear resistant performance of the flexible hose material.

In general, adding wear resistant fillers can decrease the elongation at break of the flexible hose material, but when compared with the modified wear resistant fillers with the unmodified filler that composed of only kaolins and quartz powders, the modified wear resistant fillers improve the elongation at break of the flexible hose material.

In another embodiment, a weight ratio of a total weight of kaolins and quartz powders to the weight of the water is 1:7 to 1:10.

In another embodiment, a weight ratio of a total weight of the kaolins and quartz powders and a weight of the water is 1:8.

In another embodiment, setting weight parts of the kaolins and quartz powders dispersion as 100 parts, weight parts of the molybdenum pentachloride is 2 parts to 3 parts, weight parts of the vanadium tetrachloride is 1.5 parts to 2.5 parts, and weight ratio of the potassium bicarbonate is 8 parts to 10 parts.

The modified wear resistant fillers of the present disclosure is obtained by adding modified additives to the calcined solids. When comparing the modified wear resistant fillers with existing wear resistant fillers that are not treated with the modified additives, the modified wear resistant fillers can significantly improve the wear resistant performance of the flexible hose material; at the same time, it is also can greatly improve the elongation at break of the flexible hose material.

In another embodiment, weight parts of the kaolins and quartz powders dispersion, the molybdenum pentachloide, the vanadium tetrachloride and the potassium bicarbonate are 100 parts, 2.7 parts, 1.9 parts and 9.0 parts, respectively.

In another embodiment, 9. calcining the solid filter slags at 900° C. to 1100° C. for 3 h to 5 h; after the step of calcining the solid filter slags at 900° C. to 1100° C. for 3 h to 5 h, to obtain the calcined solids, it also includes the following steps of:
adding the calcined solids to the water, to obtain calcined solids dispersion after stirring evenly;
adding modified additives after heating the calcined solids dispersion to 50° C. to 70° C., after stirring for 2 h to 4 h, performing a filtering operation to obtain modified solids, where the modified solids are the modified wear resistant fillers.

In another embodiment, a weight ratio of the calcined solids to the water is 1:5 to 1:8.

In another embodiment, a weight ratio of the calcined solids to water is 1:5 to 1:8.

In another embodiment, the weight ratio of the calcined solids to water is 1:6

In another embodiment, the calcined solids dispersion is 100 weight parts, the modified additives are 5 weight parts to 10 weight parts.

In another embodiment, the calcined solids dispersion is 100 weight parts and the modified additives is 8 weight parts.

In another embodiment, the raw material components of the modified additives include 1-Alanine, N-cocoacylderivs sodiumsalts, benzyltriethylammonium chloride and titanium tris (dodecyl benzene sulfonate) isopropoxide.

Further, the weight parts of the 1-Alanine, N-cocoacylderivs sodiumsalts, the benzyltriethylammonium chloride and the titanium tris (dodecyl benzene sulfonate) isopropoxide are 2 patrs to 4 parts, 2 patrs to 4 parts and 1 part to 3 parts, respectively.

In another embodiment, the weight parts of the 1-Alanine, N-cocoacylderivs sodiumsalts, the benzyltriethylammonium chloride and the titanium tris (dodecyl benzene sulfonate) isopropoxide are 3 parts, 3 parts and 2 parts, respectively.

The composition of the modified additives in the present disclosure is very crucial; the modified additives is composed of 3 kinds of raw raw materials: the 1-Alanine, N-cocoacylderivs sodiumsalts, the benzyltriethylammonium chloride and the titanium tris (dodecyl benzene sulfonate) isopropoxide, if calcined solids is treated with the modified additives, and then the finally obtained modified wear resistant fillers can greatly improve the elongation at break of the flexible hose material. However, if the modified wear-resistant fillers obtained by calcined solids which is only treated by any one or any two of the 1-Alanine, N-cocoacylderivs sodiumsalts, the benzyltriethylammonium chloride and the titanium tris (dodecyl benzene sulfonate) isopropoxide, and is skipping further improving the elongation at break of the flexible hose material.

In another embodiment, the solid filter slags are calcined at 1050° C. for 4 h.

In another embodiment, the thermoplastic rubber is a thermoplastic styrene butadiene rubber.

The present disclosure also provides a preparation method for a flexible hose material, including the following steps: mixing the thermoplastic rubber, the polypropylene, the wear resistant fillers, the aging agent, the dispersing agent and the coupling agent evenly, and put them into a twin-screw extruder, to obtain the flexible hose material after extrusion.

The present disclosure also provides a flexible hose material in the disclosure of water pipe, and the water pipe includes a wear resistant water pipe main body; the wear resistant water pipe main body is made by the flexible hose material of the present disclosure.

In another embodiment, the wear resistant water pipe main body is an integrated forming structure.

In another embodiment, the water pipe includes the wear resistant water pipe main body, a first end, a second end, a first coupler and a second coupler;
the wear resistant water pipe main body has a hollow single-layer structure; the wear resistant water pipe main body is configured to carry out a transverse expansion and a longitudinal expansion;
the first end is arranged at an end of the main body of the wear resistant water pipe; the second end of the water pipe is arranged at another end of the main body of the wear-resistant water pipe;
the first coupler is connected with the first end, and the second end is connected with the second coupler.

In another embodiment, the wear resistant water pipe main body concludes a fabric layer.

In another embodiment, the fabric layer is an elastic fabric layer.

In another embodiment, the elastic fabric layer includes a wear resistant nylon thread and a rubber band.

Beneficial effects:
(1) The present disclosure provides a new flexible hose material, the flexible hose material is added with the wear resistant fillers that is composed of kaolins and quartz powders and the anti-aging agent is added, compared with the flexible hose material without the wear resistant fillers and anti-aging agent, its wear resistant performance and anti-aging performance are improved. In particular, after adding the modified wear resistant fillers, can make the wear resistant performance of the flexible hose material be further greatly improved; the flexible hose material has better wear resistant performance and better elongation at break.
(2) The flexible hose material of the present disclosure has wear resistant performance and anti-aging performance; thus, the hose prepared by using it as a material also has better wear resistant performance and anti-aging performance; further, the hose that further prepared by the flexible hose material the of the present disclosure can replace the retractable flexible hose which has three layers of structure such as elastic inner layer, elastic fabric reinforcement layer and elastic outer layer disclosed by the US application U.S. Pat. No. 16,681,769; and the problems of complex structure and high production cost are solved; and has important application value.
(3) Because the flexible hose material of the present disclosure has excellent performance, the water pipe made of the hose material of the present disclosure, not only has the wear resistant performance, but also has the anti-aging performance; in particular, the wear resistant water pipe main body is provided with a layer of elastic fabric layer composed of a wear resistant nylon thread and a rubber band, which is configured to further increase the wear resistant performance of the water pipe; in addition, in the specific disclosure process, the water pipe made of the flexible hose material of the present disclosure, can carry out a transverse expansion and longitudinal expansion, and its expansion coefficient reaches more than 2.5 times; at the same time, a number of charging and discharging reaches more than 1000 times, and has a long service life.

### DETAILED DESCRIPTION OF PREFERRED EMBODIMENTS

The present disclosure is further explained below in connection with specific embodiments, but the embodiments skip in making any form of limitations on the present disclosure.

The thermoplastic rubber described in the following embodiments is a Polymerized Styrene Butadiene Rubber SBR, the product name is thermoplastic styrene butadiene rubber SBS1401E (YH-792E), and the embodiments adopt the thermoplastic styrene butadiene rubber of Sinopec with the grade YH-792E. The appearance is white or light yellow porous round or wafer shaped small particles, with the advantages of rubber and plastic, with good low temperature resistance, air permeability and wet slip resistance, easy to process and form. The polypropylene PP, the embodiments adopte polypropylene of Sinopec with the grade M800E; the rest of the raw materials are the conventional raw materials that can be purchased by personel in the field through normal channels.

### Embodiment 1 Preparation of the Flexible Hose Material

Raw material components of the flexible hose material include following ingredients in parts by weight: thermoplastic rubber 90 parts, polypropylene 30 parts, wear resistant fillers 35 parts, anti-aging agent 2 parts, dispersing agent 1 part and coupling agent 1 part;

The anti-aging agent is made up of N-cyclohexyl-N′-phenyl-p-phenylenediamine and 2, 6-di-tert-butyl-p-methylphenol with a weight ratio of 2:1; the dispersing agent is ethylene bis stearamide; the coupling agent is silane coupling agent KH-570, the chemical name of the silane coupling agent KH-570 is methacryloxy functional silane; and the wear resistant fillers includes kaolins and quartz powders, where a weight ratio of kaolins to quartz powders is 4:1.

Preparation method: the thermoplastic rubber, polypropylene, wear resistant fillers, aging agent, dispersing agent and coupling agent are evenly mixed and put into a twin-screw extruder and the flexible hose material is obtained after the operation of the twin-screw extruder.

### Embodiment 2 Preparation of the Flexible Hose Material

Raw material weight component: thermoplastic rubber 90 parts, polypropylene 30 parts, wear resistant fillers 35 parts, anti-aging agent 2 parts, dispersing agent 1 part and coupling agent 1 part;
The anti-aging agent is made up of N-cyclohexyl-N′-phenyl-p-phenylenediamine and 2, 6-di-tert-butyl-p-methylphenol with a weight ratio of 2:1; the dispersing agent is ethylene bis stearamide; the coupling agent is silane coupling agent KH-570.

The wear resistant fillers is a modified wear resistant fillers; the modified wear resistant fillers is prepared by the following steps:
(1) mixing the kaolins and the quartz powders evenly, where with a weight ratio of the kaolins to the quartz powders is 4:1, and then adding the kaolins and the quartz powders to water, to obtain a kaolins and quartz powders dispersion after ultrasonic stirring; where, the weight ratio of the total weight of kaolins and quartz powders and the weight of water is 1:8;
(2) adding molybdenum pentachloride and vanadium tetrachloride to the kaolins and quartz powders dispersion, adding potassium bicarbonate after stirring for 15 min, and then stirring continuously for 180 min; carrying out a filtration operation after stirring, and collecting solid filter slags after the filtration operation is completed; where, weight parts of the kaolins and quartz powders dispersion, the molybdenum pentachloide, the vanadium tetrachloride and the potassium bicarbonate are 100 parts, 2.7 parts, 1.9 parts and 9.0 parts, respectively;
(3) calcining the solid at 1050° C. for 4 h to the calcined solids, and the calcined solids are the modified wear resistant fillers.

Preparation method: the thermoplastic rubber, polypropylene, wear resistant fillers, aging agent, dispersing agent and coupling agent are evenly mixed and put into twin-screw extruder and the flexible hose material is obtained after the operation of the twin-screw extruder.

### Embodiment 3 Preparation of the Flexible Hose Material

Raw material weight component: thermoplastic rubber 90 parts, polypropylene 30 parts, wear resistant fillers 35 parts, anti-aging agent 2 parts, dispersing agent 1 part and coupling agent 1 part;
The anti-aging agent is made up of N-cyclohexyl-N′-phenyl-p-phenylenediamine and 2, 6-di-tert-butyl-p-methylphenol with a weight ratio of 2:1; the dispersing agent is ethylene bis stearamide; the coupling agent is silane coupling agent KH-570.

The wear resistant fillers is a modified wear resistant fillers; the modified wear resistant fillers is prepared by the following steps:
(1) mixing the kaolins and the quartz powders evenly, where with a weight ratio of the kaolins to the quartz powders is 4:1, and then adding the kaolins and the quartz powders to water, to obtain a kaolins and quartz powders dispersion after ultrasonic stirring; where, the weight ratio of the total weight of kaolins and quartz powders and the weight of water is 1:8;
(2) adding a molybdenum pentachloride and a vanadium tetrachloride to the kaolins and quartz powders dispersion, adding a potassium bicarbonate after stirring for 15 min, and then stirring continuously for 180 min; carrying out a filtration operation after stirring, and collecting solid filter slags after the filtration operation is completed; where, weight parts of the kaolins and quartz powders dispersion, the molybdenum pentachloide, the vanadium tetrachloride and the potassium bicarbonate are 100 parts, 2.7 parts, 1.9 parts and 9.0 parts, respectively;
(3) calcining the solid at 1050° C. for 4 h to the calcined solids, and the calcined solids are the modified wear resistant fillers;
(4) adding the calcined solids to water to obtain the calcined solids dispersion after stirring evenly; adding the modified additives after heating the calcined solids dispersion to 60° C., after stirring for 3 h, separating the solid, and the modified wear resistant fillers is obtained after the solid is dried; where, the weight ratio of calcined solids to water is 1:6; the weight ratio of the calcined solids dispersion to modified additives is 100:8; the weight parts of the 1-Alanine, N-cocoacylderivs sodiumsalts, the benzyltriethylammonium chloride and the titanium tris (dodecyl benzene sulfonate) isopropoxide of the modified additives are 3 parts, 3 parts and 2 parts, respectively.

Preparation method: the thermoplastic rubber, polypropylene, wear resistant fillers, aging agent, dispersing agent and coupling agent are evenly mixed and put into a twin-screw extruder and the flexible hose material is obtained after the operation of the twin-screw extruder.

In order to obtain the flexible hose material with excellent performance, embodiments 4-7 are also set in the present disclosure, embodiments 4-7 is the same as the basic operation of embodiment 3, but they are different in some setting datas, and the specific setting datas are shown in table 1, table 2 and table 3.

TABLE 1
The weight component of the raw material referred to
in embodiment 4 to embodiment 7 of the disclosure

| | column 1 | column 2 | column 3 | column 4 | column 5 | column 6 | column 7 |
|---|---|---|---|---|---|---|---|
| Embodiment 4 | 80 | 20 | 30 | 1 | 2 | 3 | 3:5 |
| Embodiment 5 | 85 | 28 | 29 | 2.5 | 1.5 | 2 | 3:1 |
| Embodiment 6 | 95 | 40 | 38 | 1.5 | 2.5 | 2.8 | 3:2 |
| Embodiment 7 | 100 | 39 | 40 | 3 | 3 | 0.9 | 3:3 |

In table 1, columns 1-6 are weights of thermoplastic rubber, polypropylene, wear resistant fillers, anti-aging agent and dispersing agent, coupling agent, respectively, column 7 is weight ratio of kaolins to quartz powders in wear resistant fillers.

TABLE 2
The parameters involved in the preparation process of modified wear
resistant fillers in embodiment 4 to embodiment 7 of the disclosure.

| | column 1 | column 2 | column 3 | column 4 | column 5 | column 6 | column 7 | column 8 | column 9 |
|---|---|---|---|---|---|---|---|---|---|
| Embodiment 4 | 10 | 120 | 900 | 4.5 | 1:7.8 | 100 | 2 | 1.5 | 8 |
| Embodiment 5 | 20 | 140 | 960 | 3 | 1:8.5 | 100 | 2.5 | 2 | 8.5 |
| Embodiment 6 | 18 | 170 | 1000 | 3.5 | 1:9 | 100 | 2.8 | 2.3 | 9.5 |
| Embodiment 7 | 11 | 200 | 1090 | 5 | 1:10 | 100 | 3 | 2.5 | 10 |

In table 2, columns 1-9 are stirring time before adding potassium bicarbonate, stirring time after adding potassium bicarbonate, calcination temperature, calcination time, weight ratio of Kaolins and quartz powders by total to water, weight parts of kaolins and quartz powders dispersion, molybdenum pentachloride, vanadium tetrachloride and potassium bicarbonate.

TABLE 3
List of ingredients of the modified additives involved
in embodiments 4 to 7 of this disclosure.

| | column 1 | column 2 | column 3 | column 14 |
|---|---|---|---|---|
| Embodiment 4 | 100:5 | 2 | 4 | 2 |
| Embodiment 5 | 100:6 | 2.5 | 3.5 | 3.8 |
| Embodiment 6 | 100:7 | 3.5 | 2.5 | 2.3 |
| Embodiment 7 | 100:8 | 4 | 2 | 4 |

In table 3, columns 1 is weight parts ratio of calcined solids dispersion to modified additives, columns 2-4 are weight parts of 1-Alanine, N-cocoacylderivs sodiumsalts, benzyltriethylammonium chloride and titanium tris (dodecyl benzene sulfonate) isopropoxide.

### Contrast Embodiment 1 Preparation of the Flexible Hose Material

The difference between the contrast embodiment 1 and the embodiment 3 is that the component of the modified additives adopted in the preparation step (4) of the modified wear resistant fillers is different; the rest are the same as embodiment 3.

The wear resistant fillers is a modified wear resistant fillers; the modified wear resistant fillers is prepared by the following steps:
(1) mixing the kaolins and the quartz powders with a weight ratio of 4:1 evenly, and then adding the kaolins and the quartz powders to water, to obtain a kaolins and quartz powders dispersion after ultrasonic stirring; where, the weight ratio of the total weight of kaolins and quartz powders and the weight of water is 1:8;
(2) adding a molybdenum pentachloride and a vanadium tetrachloride to the kaolins and quartz powders dispersion, adding a potassium bicarbonate after stirring for 15 min, and then stirring continuously for 180 min; carrying out a filtration operation after stirring, and collecting solid filter slags after the filtration operation is completed; where, weight parts of the kaolins and quartz powders dispersion, the molybdenum pentachloide, the vanadium tetrachloride and the potassium bicarbonate are 100 parts, 2.7 parts, 1.9 parts and 9.0 parts, respectively;
(3) calcining the solid at 1050° C. for 4 h to the calcined solids, and the calcined solids are the modified wear resistant fillers;
(4) adding the calcined solids to the water, and to obtain the calcined solids dispersion after stirring evenly; adding the modified additives after heating the calcined solids dispersion to 60° C., after stirring for 3 h, separating the solid, and the modified wear resistant fillers is obtained after the solid is dried; where, the weight ratio of calcined solids to water is 1:6; the weight ratio of the calcined solids dispersion to modified additives is 100:8; the modified additives is 1-Alanine, N-cocoacylderivs sodiumsalts.

### Contrast Embodiment 2 Preparation of the Flexible Hose Material

The difference between the contrast embodiment 2 and the embodiment 3 is that the component of the modified additives adopted in the preparation step (4) of the modified wear resistant fillers is different; the rest are the same as embodiment 3.

The wear resistant fillers is a modified wear resistant fillers; the modified wear resistant fillers is prepared by the following steps:
(1) mixing the kaolins and the quartz powders with a weight ratio of 4:1 evenly, and then adding the kaolins and the quartz powders to water, to obtain a kaolins and quartz powders dispersion after ultrasonic stirring; where, the weight ratio of the total weight of kaolins and quartz powders and the weight of water is 1:8;
(2) adding a molybdenum pentachloride and a vanadium tetrachloride to the kaolins and quartz powders dispersion, adding a potassium bicarbonate after stirring for 15 min, and then stirring continuously for 180 min; carrying out a filtration operation after stirring, and collecting solid filter slags after the filtration operation is completed; where, weight parts of the kaolins and quartz powders dispersion, the molybdenum pentachloide, the vanadium tetrachloride and the potassium bicarbonate are 100 parts, 2.7 parts, 1.9 parts and 9.0 parts, respectively;
(3) calcining the solid at 1050° C. for 4 h to the calcined solids, and the calcined solids are the modified wear resistant fillers;
(4) adding the calcined solids to the water, and to obtain the calcined solids dispersion after stirring evenly; adding the modified additives after heating the calcined solids dispersion to 60° C., after stirring for 3 h, separating the solid, and the modified wear resistant fillers is obtained after the solid is dried; where, the weight ratio of calcined solids to water is 1:6; the weight ratio of the calcined solids dispersion to modified additives is 100:8; the modified additives is benzyltriethylammonium chloride.

### Contrast Embodiment 3 Preparation of the Flexible Hose Material

The difference between the contrast embodiment 3 and the embodiment 3 is that the modified additives adopted in the preparation step (4) of the modified wear resistant fillers is different; the rest are the same as in embodiment 3.

The wear resistant fillers is a modified wear resistant fillers; the modified wear resistant fillers is prepared by the following steps:
(1) mixing the kaolins and the quartz powders with a weight ratio of 4:1 evenly, and then adding the kaolins and the quartz powders to water, to obtain a kaolins and quartz powders dispersion after ultrasonic stirring; where, the weight ratio of the total weight of kaolins and quartz powders and the weight of water is 1:8;
(2) adding a molybdenum pentachloride and a vanadium tetrachloride to the kaolins and quartz powders dispersion, adding a potassium bicarbonate after stirring for 15 min, and then stirring continuously for 180 min; carrying out a filtration operation after stirring, and collecting solid filter slags after the filtration operation is completed; where, weight parts of the kaolins and quartz powders dispersion, the molybdenum pentachloide, the vanadium tetrachloride and the potassium bicarbonate are 100 parts, 2.7 parts, 1.9 parts and 9.0 parts, respectively;
(3) calcining the solid at 1050° C. for 4 h to the calcined solids, and the calcined solids are the modified wear resistant fillers;
(4) adding the calcined solids to the water, and to obtain the calcined solids dispersion after stirring evenly; adding the modified additives after heating the calcined solids dispersion to 60° C., after stirring for 3 h, separating the solid, and the modified wear resistant fillers is obtained after the solid is dried; where, the weight ratio of calcined solids to water is 1:6; the weight ratio of the calcined solids dispersion to modified additives is 100:8; the modified additives is titanium tris (dodecyl benzene sulfonate) isopropoxide.

### Contrast Embodiment 4 Preparation of the Flexible Hose Material

The difference between the contrast embodiment 4 and the embodiment 3 is that the modified additives adopted in the preparation step (4) of the modified wear resistant fillers is different; the rest are the same as in embodiment 3.

The wear resistant fillers is a modified wear resistant fillers; the modified wear resistant fillers is prepared by the following steps:
(1) mixing the kaolins and the quartz powders with a weight ratio of 4:1 evenly, and then adding the kaolins and the quartz powders to water, to obtain a kaolins and quartz powders dispersion after ultrasonic stirring; where, the weight ratio of the total weight of kaolins and quartz powders and the weight of water is 1:8;
(2) adding a molybdenum pentachloride and a vanadium tetrachloride to the kaolins and quartz powders dispersion, adding a potassium bicarbonate after stirring for 15 min, and then stirring continuously for 180 min; carrying out a filtration operation after stirring, and collecting solid filter slags after the filtration operation is completed; where, weight parts of the kaolins and quartz powders dispersion, the molybdenum pentachloide, the vanadium tetrachloride and the potassium bicarbonate are 100 parts, 2.7 parts, 1.9 parts and 9.0 parts, respectively;
(3) calcining the solid at 1050° C. for 4 h to the calcined solids, and the calcined solids are the modified wear resistant fillers;
(4) adding the calcined solids to the water, and to obtain the calcined solids dispersion after stirring evenly; adding the modified additives after heating the calcined solids dispersion to 60° C., after stirring for 3 h, separating the solid, and the modified wear resistant fillers is obtained after the solid is dried; where, the weight ratio of calcined solids to water is 1:6; the weight ratio of the calcined solids dispersion to modified additives is 100:8; the modified additives consist of the 1-Alanine, N-cocoacylderivs sodiumsalts and the titanium tris (dodecyl benzene sulfonate) isopropoxide, and weight parts of the 1-Alanine, N-cocoacylderivs sodiumsalts and the titanium tris (dodecyl benzene sulfonate) isopropoxide are 3 parts and 2 parts, respectively.

### Contrast Embodiment 5 Preparation of the Flexible Hose Material

The difference between the contrast embodiment 5 and the embodiment 3 is that the modified additives adopted in the preparation step (4) of the modified wear resistant fillers are different; the rest are the same as in embodiment 3.

The wear resistant fillers is a modified wear resistant fillers; the modified wear resistant fillers is prepared by the following steps:
(1) mixing the kaolins and the quartz powders with a weight ratio of 4:1 evenly, and then adding the kaolins and the quartz powders to water, to obtain a kaolins and quartz powders dispersion after ultrasonic stirring; where, the weight ratio of the total weight of kaolins and quartz powders and the weight of water is 1:8;
(2) adding a molybdenum pentachloride and a vanadium tetrachloride to the kaolins and quartz powders dispersion, adding a potassium bicarbonate after stirring for 15 min, and then stirring continuously for 180 min; carrying out a filtration operation after stirring, and collecting solid filter slags after the filtration operation is completed; where, weight parts of the kaolins and quartz powders dispersion, the molybdenum pentachloide, the vanadium tetrachloride and the potassium bicarbonate are 100 parts, 2.7 parts, 1.9 parts and 9.0 parts, respectively;
(3) calcining the solid at 1050° C. for 4 h to the calcined solids, and the calcined solids are the modified wear resistant fillers;
(4) adding the calcined solids to the water, and to obtain the calcined solids dispersion after stirring evenly; adding the modified additives after heating the calcined solids dispersion to 60° C., after stirring for 3 h, separating the solid, and the modified wear resistant fillers is obtained after the solid is dried; where, the weight ratio of calcined solids to water is 1:6; the weight ratio of the calcined solids dispersion to modified additives is 100:8; the modified additives consist of the benzyltriethylammonium chloride and the titanium tris (dodecyl benzene sulfonate) and isopropoxide, weight parts of the benzyltriethylammonium chloride to the titanium tris (dodecyl benzene sulfonate) isopropoxide 3 parts and 2 parts, respectively.

### Contrast Embodiment 6 Preparation of the Flexible Hose Material

The difference between the contrast embodiment 6 and the embodiment 3 is that the modified additives adopted in the preparation step (4) of the modified wear resistant fillers are different; the rest are the same as in embodiment 3.

The wear resistant fillers is a modified wear resistant fillers; the modified wear resistant fillers is prepared by the following steps:
(1) mixing the kaolins and the quartz powders with a weight ratio of 4:1 evenly, and then adding the kaolins and the quartz powders to water, to obtain a kaolins and quartz powders dispersion after ultrasonic stirring; where, the weight ratio of the total weight of kaolins and quartz powders and the weight of water is 1:8;
2) adding a molybdenum pentachloride and a vanadium tetrachloride to the kaolins and quartz powders dispersion, adding a potassium bicarbonate after stirring for 15 min, and then stirring continuously for 180 min; carrying out a filtration operation after stirring, and collecting solid filter slags after the filtration operation is completed; where, weight parts of the kaolins and quartz powders dispersion, the molybdenum pentachloide, the vanadium tetrachloride and the potassium bicarbonate are 100 parts, 2.7 parts, 1.9 parts and 9.0 parts, respectively;
(3) calcining the solid at 1050° C. for 4 h to the calcined solids, and the calcined solids are the modified wear resistant fillers;
(4) adding the calcined solids to the water, and to obtain the calcined solids dispersion after stirring evenly; adding the modified additives after heating the calcined solids dispersion to 60° C., after stirring for 3 h, separating the solid, and the modified wear resistant fillers is obtained after the solid is dried; where, the weight ratio of calcined solids to water is 1:6; the weight ratio of the calcined solids dispersion to modified additives is 100:8; the modified additives consist of the weight parts of the 1-Alanine, N-cocoacylderivs sodiumsalts and the benzyltriethylammonium chloride, and weight part of the 1-Alanine, N-cocoacylderivs sodiumsalts and the benzyltriethylammonium chloride is 1 part and 1 part, respectively.

### Test Experiment

The wear volume of the flexible hose material prepared in embodiments 1-3 and contrast embodiments 1-6 was tested according to Rubber vulcanized-Determination of abrasion resistance (Akron machine); the elongation at break was tested according to Rubber of plastics-coated fabrics Determination of tensile strength and elongation at break; the test results are shown in Table 4.

The testing of wear volume based on an Akron machine, mainly includes the following steps:
Putting the flexible hose material on the sample wheel, fixing the sample wheel onto the rubber wheel shaft, starting the motor, and rotate the flexible hose material clockwise for 15 to 20 minutes before pre grinding the flexible hose material. Removing the flexible hose material, brush it clean, and weigh its weight to the nearest 0.001 g, to get a first weight of the flexible hose material;
Conducting the flexible hose material using pre ground specimens. After driving the flexible hose material for 1.61 km, turn off the motor, removing the flexible hose material, brushing off the rubber debris, and weigh within 1 hour, accurate to 0.001 g, to get a second weight of the flexible hose material;
Calculating and measure the density of flexible hose material;
Dividing the difference between the first weight and the second weight by the density flexible hose material, and taking the results as wear volume.

The testing of elongation at break is based on a tensile testing machine, and the test procedure includes install the flexible hose material, Moving the flexible hose material at different to obtain several elongation at breaks, taking an average elongation at break of the several elongation at breaks as the final result.

TABLE 4
The performance test result of the flexible
hose material of the present disclosure.

| | | elongation |
|---|---|---|
| | wear volume | at break |
| The flexible hose material prepared in | 0.266 cm³ | 510% |
| embodiment 1 | | |
| The flexible hose material prepared in | 0.154 cm³ | 560% |
| embodiment 2 | | |
| The flexible hose material prepared in | 0.126 cm³ | 750% |
| embodiment 3 | | |
| The flexible hose material prepared in | 0.135 cm³ | 640% |
| contrast embodiment 1 | | |
| The flexible hose material prepared in | 0.130 cm³ | 610% |
| contrast embodiment 2 | | |
| The flexible hose material prepared in | 0.147 cm³ | 580% |
| contrast embodiment 3 | | |
| The flexible hose material prepared in | 0.144 cm³ | 610% |
| contrast embodiment 4 | | |
| The flexible hose material prepared in | 0.140 cm³ | 600% |
| contrast embodiment 5 | | |
| The flexible hose material prepared in | 0.132 cm³ | 630% |
| contrast embodiment 6 | | |

It can be seen from the experimental data in Table 1 that the wear volume of the flexible hose material prepared in embodiment 1 reached 0.266 cm³, which indicates that the present disclosure has good wear resistant performance by adding a wear resistant fillers composed of kaolins and quartz powders to the flexible hose material.

It can also be seen from the experimental datas in Table 1 that the wear volume of the flexible hose material prepared in embodiment 2 is substantially smaller than that of the flexible hose material prepared in embodiment 1; which indicates: the modified wear resistant fillers prepared by modifying kaolins and quartz powders through the method of the present disclosure is added to the flexible hose material, compared with adding the unmodified filler that is composed of kaolins and quartz powders, can improve the wear resistant performance of the flexible hose material.

It can also be seen from the experimental data in Table 1 that the wear volume of the flexible hose material prepared in embodiment 3 is further significantly smaller than that of the flexible hose material prepared in embodiment 2; which indicates: in the preparation process of the modified wear resistant fillers, the modified wear resistant fillers obtained by further treating the calcined solids through the modified additives of the present disclosure, compared with the modified wear-resistant fillers that is obtained after not being treated with the modified additives of the present disclosure, can further significantly improve the wear resistant performance of the flexible hose material.

It can also be seen from the experimental data in Table 1 that the elongation at break of the flexible hose material prepared in embodiment 2 is greater than that prepared in embodiment 1; which indicates that: the modified wear resistant fillers prepared by modifying kaolins and quartz powders through the method of the present disclosure is added to the flexible hose material, compared with adding the unmodified filler that is composed of kaolins and quartz powders, helps to improve the elongation at break of the flexible hose material.

It can also be seen from the experimental data in Table 1 that the elongation at break of the flexible hose material prepared in embodiment 3 is further substantially greater than the hose material prepared in embodiment 2; in the preparation process of the modified wear resistant fillers, the modified wear resistant fillers obtained by further treating the calcined solids through the modified additives of the present disclosure, compared with the modified wear-resistant fillers that is obtained after not being treated with the modified additives of the present disclosure, can greatly improve the elongation at break of the flexible hose material.

It can also be seen from the experimental data in Table 1 that the elongation at break of the flexible hose material prepared in the contrast embodiment 1 to contrast embodiment 6 is improved compared with that of embodiment 2, but the improvement is not large, and the improvement is much smaller than that of the flexible hose material prepared in embodiment 3; which indicates that: the composition of the modified additives in the present disclosure is very crucial; the modified wear resistant fillers obtained only by further treating the calcined solids through the modified additives composed of the 1-Alanine, N-cocoacylderivs sodiumsalts, the benzyltriethylammonium chloride and the titanium tris (dodecyl benzene sulfonate) isopropoxide of the present disclosure, is configured to further greatly improve the elongation at break of the flexible hose material. However, in the preparation process of modified wear resistant fillers, the modified wear-resistant fillers obtained by calcined solids only by using any one or any two of the modified additives composed of the 1-Alanine, N-cocoacylderivs sodiumsalts, the benzyltriethylammonium chloride and the titanium tris (dodecyl benzene sulfonate) isopropoxide is skipped in improving the elongation at break of the flexible hose material.

### Embodiment 8

The embodiment provides a water pipe; the water pipe includes the wear resistant water pipe main body, a first end, a second end, a first coupler and a second coupler; the first end is arranged at an end of the main body of the wear resistant water pipe; the second end of the water pipe is arranged at another end of the main body of the wear-resistant water pipe; the first coupler is connected with the first end, and the second end is connected with the second coupler; the wear resistant water pipe main body includes an elastic fabric layer composed of a wear resistant nylon thread and a rubber band.

In particular, the wear resistant water pipe main body is an integrated forming and hollow single-layer structure, which is prepared in the flexible hose material prepared in embodiment 3; and is configured to carry out a transverse expansion and a longitudinal expansion;

We claim:

1. A flexible hose material, wherein, raw material components of the flexible hose material comprise following ingredients in parts by weight: thermoplastic rubber 80 parts to 100 parts, polypropylene 20 parts to 40 parts, wear resistant fillers 30 parts to 40 parts, anti-aging agent 1 part to 3 parts, dispersing agent 1 part to 3 parts and coupling agent 1 part to 3 parts;
the wear resistant fillers comprise kaolins and the quartz powders.

2. The flexible hose material according to claim 1, wherein, raw material components of the flexible hose material comprise following ingredients in parts by weight: thermoplastic rubber 90 parts to 100 parts, polypropylene 20 parts to 30 parts, wear resistant fillers 30 parts to 35 parts, anti-aging agent 2 parts to 3 parts, dispersing agent 1 parts to 2 parts and coupling agent 1 parts to 2 parts.

3. The flexible hose material according to claim 1, wherein, a weight ratio of kaolins to quartz powders in the wear resistant fillers is 3:5 to 3:1.

4. The flexible hose material according to claim 1, wherein, the wear resistant fillers is a modified wear resistant fillers; the modified wear resistant fillers is prepared by the following steps:
mixing the kaolins and the quartz powders evenly, and then adding the kaolins and the quartz powders to water, to obtain kaolins and quartz powders dispersion after ultrasonic stirring;
adding molybdenum pentachloride and vanadium tetrachloride to the kaolins and quartz powders dispersion, adding potassium bicarbonate after stirring for 10 min to 20 min, and then stirring continuously for 120 min to 200 min; carrying out a filtration operation after stirring, and collecting solid filter slags after the filtration operation is completed;
calcining the solid filter slags at 900° C. to 1100° C. for 3 h to 5 h, to obtain the calcined solids after the end of calcination, and the calcined solids are the modified wear resistant fillers.

5. The flexible hose material according to claim 4, wherein, a weight ratio of a total weight of the kaolins and quartz powders and the weight of the water is 1:7 to 1:10.

6. The flexible hose material according to claim 4, wherein, a weight ratio of a total weight of the kaolins and quartz powders and a weight of the water is 1:8.

7. The flexible hose material according to claim 4, wherein, setting weight parts of the kaolins and quartz powders dispersion as 100 parts, weight parts of the molybdenum pentachloride is 2 parts to 3 parts, weight parts of the vanadium tetrachloride is 1.5 parts to 2.5 parts, and weight ratio of the potassium bicarbonate is 8 parts to 10 parts.

8. The flexible hose material according to claim 4, wherein, weight parts of the kaolins and quartz powders dispersion, the molybdenum pentachloide, the vanadium tetrachloride and the potassium bicarbonate are 100 parts, 2.7 parts, 1.9 parts and 9.0 parts, respectively.

9. The flexible hose material according to claim 4, wherein, calcining the solid filter slags at 900° C. to 1100° C. for 3 h to 5 h; after the step of calcining the solid filter slags at 900° C. to 1100° C. for 3 h to 5 h, to obtain the calcined solids, it also comprises the following steps of:
adding the calcined solids to the water, to obtain calcined solids dispersion after stirring evenly;
adding modified additives after heating the calcined solids dispersion to 50° C. to 70° C., after stirring for 2 h to 4 h, performing a filtering operation to obtain modified solids, where the modified solids are the modified wear resistant fillers.

10. The flexible hose material according to claim 9, wherein, a weight ratio of the calcined solids to the water is 1:5 to 1:8.

11. The flexible hose material according to claim 9, wherein, the calcined solids dispersion is 100 weight parts, the modified additives are 5 weight parts to 10 weight parts;

12. The flexible hose material according to claim 9, wherein, the calcined solids dispersion is 100 weight parts and the modified additives is 8 weight parts.

13. The flexible hose material according to claim 9, wherein, the raw material components of the modified additives comprise 3 kinds of raw materials: 1-Alanine, N-cocoacylderivs sodiumsalts, benzyltriethylammonium chloride and titanium tris (dodecyl benzene sulfonate) isopropoxide14.;
where, weight parts of the 1-Alanine, N-cocoacylderivs sodiumsalts in the modified additives are 2 parts to 4 parts, weight parts of the benzyltriethylammonium chloride is 2 parts to 4 parts, and weight parts of the titanium tris (dodecyl benzene sulfonate) isopropoxide are 1 part to 3 parts.

14. The flexible hose material according to claim 13, wherein, weight parts of the 1-Alanine, N-cocoacylderivs sodiumsalts, the benzyltriethylammonium chloride and the titanium tris (dodecyl benzene sulfonate) isopropoxide are 3 parts, 3 parts and 2 parts, respectively.

15. A water pipe made of a flexible hose material, wherein, the water pipe comprises a wear resistant water pipe main body; the wear resistant water pipe main body is made by the flexible hose material;
raw material components of the flexible hose material comprise following ingredients in parts by weight: thermoplastic rubber 80 parts to 100 parts, polypropylene 20 parts to 40 parts, wear resistant fillers 30 parts to 40 parts, anti-aging agent 1 part to 3 parts, dispersing agent 1 part to 3 parts and coupling agent 1 part to 3 parts; where, the wear resistant fillers comprise kaolins and quartz powders.

16. The water pipe made of the flexible hose material according to claim 15, wherein, the wear resistant water pipe main body is an integrated forming structure.

17. The water pipe made of the flexible hose material according to claim 15, wherein, the water pipe comprises the wear resistant water pipe main body, a first end, a second end, a first coupler and a second coupler;
the wear resistant water pipe main body has a hollow single-layer structure; the wear resistant water pipe main body is configured to carry out a transverse expansion and a longitudinal expansion;
the first end is arranged at an end of the main body of the wear resistant water pipe; the second end of the water pipe is arranged at another end of the main body of the wear-resistant water pipe; and
the first coupler is connected with the first end, and the second end is connected with the second coupler.

18. The water pipe made of the flexible hose material according to claim 16, wherein, the wear resistant water pipe main body comprises a fabric layer.

19. The water pipe made of the flexible hose material according to claim 18, wherein, the fabric layer is an elastic fabric layer.

20. The water pipe made of the flexible hose material according to claim 19, wherein, the elastic fabric layer comprises a wear resistant nylon thread and a rubber band.
